(19) United States
(12) Patent Application Publication
(10) Pub. No.: US 2022/0247647 A1
(43) Pub. Date: Aug. 4, 2022

(54) NETWORK TRAFFIC GRAPH

(71) Applicant: Tigera, Inc., San Francisco, CA (US)

(72) Inventors: Robert Brockbank, San Francisco, CA (US); Alexander Varshavsky, San Francisco, CA (US); Manish Haridas Sampat, San Jose, CA (US); Brendan Creane, El Cerrito, CA (US); Karthik Krishnan Ramasubramanian, Newark, CA (US); Phillip DiCorpo, San Francisco, CA (US)

(21) Appl. No.: 17/524,555

(22) Filed: Nov. 11, 2021

Related U.S. Application Data
(60) Provisional application No. 63/143,509, filed on Jan. 29, 2021.

(51) Int. Cl. H04L 43/045; H04L 43/062; H04L 43/0811; H04L 43/0882; H04L 47/125

(52) U.S. Cl. CPC H04L 43/045; H04L 43/062; H04L 47/125; H04L 43/0882; H04L 43/0811

(57) ABSTRACT

A plurality of flow logs associated with a plurality of computing units are aggregated. For each flow event included in the plurality of flow logs a corresponding namespace with which the flow event is associated is determined including by determining a corresponding intermediary associated with the flow event. A network traffic map that visualizes network traffic between a plurality of namespaces is generated based in part on the determined intermediaries associated with the flow events.

### CROSS REFERENCE TO OTHER APPLICATIONS

This application claims priority to U.S. Provisional Patent Application No. 63/143,509 entitled NETWORK TRAFFIC GRAPH filed Jan. 29, 2021 which is incorporated herein by reference for all purposes.

### BACKGROUND OF THE INVENTION

A containerized application includes a plurality of services that perform isolated tasks and communicate with each other. Containerized applications are implemented by deploying computing units (e.g., pods) to computing unit hosts (e.g., virtual machines). The computing unit hosts are hosted on a physical cluster. A namespace is a virtual cluster backed by a physical cluster. A plurality of namespaces may be backed by the same physical cluster. A namespace includes a plurality of services, each of which include one or more computing units. The one or more computing units associated with a service have a corresponding internet protocol (IP) address. Each service has a corresponding IP address that is different from the IP addresses of the one or more computing units associated with the service. Namespaces are logically separated from each other, but have the ability to communicate with each other. It is difficult to visualize how network traffic is communicated between namespaces and within a namespace because flow events are collected at the computing unit level.

### BRIEF DESCRIPTION OF THE DRAWINGS

Various embodiments of the invention are disclosed in the following detailed description and the accompanying drawings.

FIG. 1 is a block diagram illustrating an embodiment of a system for generating network traffic graphs.

FIG. 2A is a flow diagram illustrating an embodiment of a process of generating a network traffic graph.

FIG. 2B is a flow diagram illustrating an embodiment of a process for associating flow events with their corresponding namespace.

FIG. 3 is a diagram illustrating an embodiment of a network traffic graph.

FIG. 4A is a diagram illustrating an embodiment of a network traffic graph.

FIG. 4B is a diagram illustrating an embodiment of a network traffic graph.

FIG. 5A is a diagram illustrating an embodiment of a network traffic graph.

FIG. 5B is a diagram illustrating an embodiment of a network traffic graph.

FIG. 5C is a diagram illustrating an embodiment of a network traffic graph.

FIG. 6A is a diagram illustrating an embodiment of a network traffic graph.

FIG. 6B is a diagram illustrating an embodiment of a network traffic graph.

FIG. 6C is a diagram illustrating an embodiment of a network traffic graph.

FIG. 7 is a block diagram illustrating an embodiment of a computing environment.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A technique to visualize network traffic is disclosed herein. In various embodiments, a plurality of flow logs associated with a plurality of computing units are aggregated. Flow events included in the plurality of flow logs are associated with a corresponding namespace including by determining a corresponding intermediary associated with the flow events. A network traffic map that visualizes network traffic between a plurality of namespaces, based in part on the determined intermediaries associated with the flow events, is generated.

When a computing unit sends or receives a data packet, a kernel of the computing unit host associated with the computing unit is configured to generate a flow event. The flow event includes a standard 5-tuple flow data (e.g., source IP address, source port, destination IP address, destination port, protocol). The flow event indicates that the data packet was sent using a protocol from a first endpoint having the source IP address and the source port to a second endpoint having the destination IP address and the destination port.

Computing units are ephemeral in nature. Without more information, it is difficult to determine which namespace the information associated with a flow event is associated because an IP address associated with a computing unit may be associated with different services or namespaces at different points in time. A flow log agent hosted on a computing unit host to which the computing unit is associated is configured to generate a scalable network flow event by combining the information associated with a flow event with additional information associated with computing unit. The additional information may include a cluster identity, a namespace identity, a computing unit identity, one or more computing unit labels, and/or network metrics associated with the flow event. This enables communications of data packets between different namespaces to be tracked.

A data packet may be provided to one or more services associated with a namespace before it arrives at the destination endpoint. The path that a data packet travels within a namespace is unable to be determined by only using the information included in a flow event. Network address translation is performed on the data packet before it arrives at the destination endpoint. The technique described herein allows the network address translation that was performed on a data packet to be determined. This allows network traffic graphs that depict network traffic flow between namespaces and between services within a namespace to be generated and visualized.

A computing environment includes a plurality of computing unit hosts, each having a corresponding flow log agent. When a data packet is received at a service, the data packet is load balanced to one of a plurality computing units associated with the service. A kernel associated with the computing unit host performs load balancing by using IP tables, which are a set of rules that describe how to handle data packets having certain characteristics. The flow log agent may utilize a connection tracking module (herein referred to as “conntrack module”) to monitor the data packet as it travels within a computing unit host. The flow log agent subsequently modifies a flow log to include connection tracking information, which indicates how a data packet was network address translated and load balanced by the kernel using IP tables. For example, the flow log may indicate that a flow event for a data packet was sent from a first endpoint, received by a service having an associated IP address, network address translated, and then load balanced to the second endpoint.

The flow log agent includes an eBPF (Berkeley Packet Filter) that is attached to the kernel. The eBPF analyzes the data packets to generate statistics associated with data packets traveling between services within a namespace and data packets traveling between namespaces, and data packets traveling between a namespace and a non-namespace entity (e.g., namespace A sends data to a private network).

Each flow log agent is configured to provide the flow events in a flow log to a flow log receiver. The flow log receiver is configured to store the flow log in a flow log store and to aggregate the flow events based at a namespace level. A flow log visualizer may utilize the aggregated flow events to generate one or more network traffic graphs. For example, the flow log visualizer may determine flow events associated with a service having a particular IP address to visualize how network flows in and out of the service. A network traffic graph may indicate a direction of network traffic between namespaces (e.g., namespace A sends data to namespace B), a direction of network traffic between a namespace and a non-namespace entity (e.g., namespace A sends data to a private network), and/or network traffic within a namespace. The flow log visualizer presents namespace information in a digestible manner for users. This enables users to understand how network traffic flows to, from, and within a namespace.

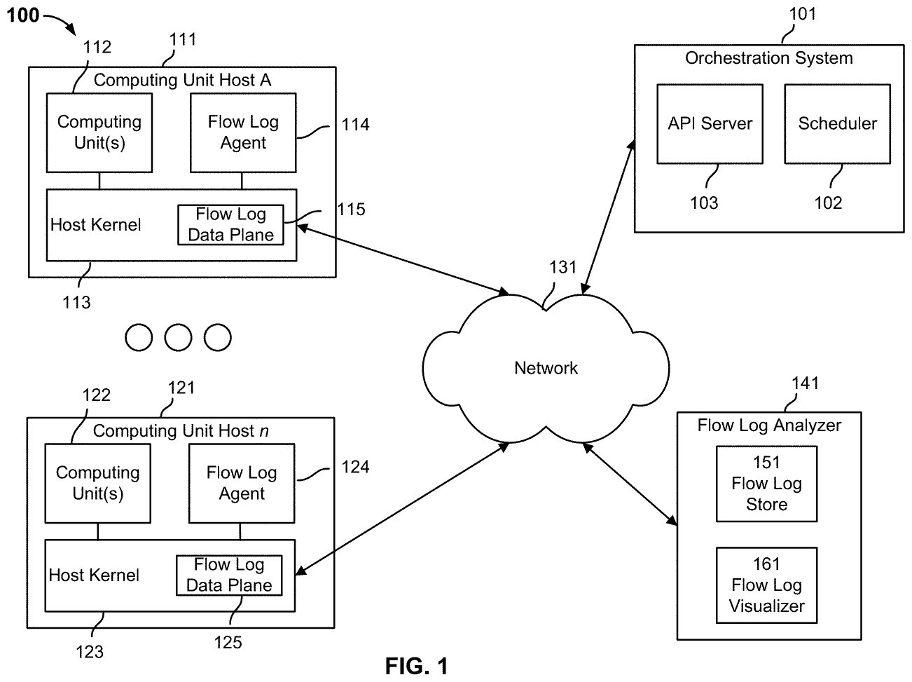

FIG. 1 is a block diagram illustrating an embodiment of a system for generating network traffic graphs. In the example shown, system 100 includes orchestration system 101, host 111, host 121, network 131, and flow log analyzer 141.

System 100 includes one or more servers hosting a plurality of computing unit hosts. Although system 100 depicts two computing unit hosts, system 100 may include n computing unit hosts where n is an integer greater than or equal to one. In some embodiments, a computing unit hosts 111, 121 are virtual machines running on a computing device, such as a computer, server, etc. In other embodiments, computing unit hosts 111, 121 are running on a computing device, such as on-prem servers, laptops, desktops, mobile electronic devices (e.g., smartphone, smartwatch), etc. In other embodiments, computing unit hosts 111, 121 are a combination of virtual machines running on one or more computing devices and one or more computing devices.

Computing unit hosts 111, 121 are configured to run a corresponding operating system (e.g., Windows, MacOS, Linux, etc.) and include a corresponding kernel 113, 123 (e.g., Windows kernel, MacOS kernel, Linux kernel, etc.). Computing unit hosts 111, 121 include a corresponding set of one or more computing units 112, 122. A computing unit (e.g., a pod) is the smallest deployable unit of computing that can be created to run one or more virtualization containers with shared storage and network resources. In some embodiments, a computing unit is configured to run a single instance of a virtualization container (e.g. microservice). In some embodiments, a computing unit is configured to run a plurality of virtualization containers.

Orchestration system 101 is configured to automate, deploy, scale, and manage containerized applications. Orchestration system 101 is configured to generate a plurality of computing units. Orchestration system 101 includes a scheduler 102. Scheduler 102 may be configured to deploy the computing units to one or more computing unit hosts 111, 121. In some embodiments, the computing units are deployed to the same computing unit host. In other embodiments, the computing units are deployed to a plurality of computing unit hosts.

Scheduler 102 may deploy a computing unit to a computing unit host based on a label attached to the computing unit. The label may be a key-value pair. Labels are intended to be used to specify identifying attributes of the computing unit that are meaningful and relevant to users, but do not directly imply semantics to the core system. Labels may be used to organize and to select subsets of computing units. Labels can be attached to a computing unit at creation time and subsequently added and modified at any time.

A computing unit may have associated metadata. For example, the associated metadata may be associated with a cluster identity, a namespace identity, a computing unit identity, and/or one or more computing unit labels. The cluster identity identifies a cluster to which the computing unit is associated. The namespace identity identifies a virtual cluster to which the computing unit is associated. System 100 may support multiple virtual clusters backed by the same physical cluster. These virtual clusters are called namespaces. For example, system 100 may include namespaces such as “default,” “kube-system” (a namespace for objects created by an orchestration system, such as Kubernetes), and “kube-public” (a namespace created automatically and is readable by all users). The computing unit identity identifies the computing unit. A computing unit is assigned a unique ID.

The metadata associated with a computing unit may be stored by API Server 103. API Server 103 is configured to store the names and locations of each computing unit in system 100. API Server 103 may be configured to communicate using JSON. API Server 103 is configured to process and validate REST requests and update state of the API objects in etcd (a distributed key value datastore), thereby allowing users to configure computing unit and virtualization containers across computing unit hosts.

A computing unit includes one or more virtualization containers. A virtualization container is configured to implement a virtual instance of a single application or microservice. The one or more virtualization containers of the computing unit are configured to share the same resources and local network of the computing unit host on which the computing unit is deployed.

When deployed to a computing unit host, a computing unit has an associated IP address. The associated IP address is shared by the one or more virtualization containers of a computing unit. The lifetime of a computing unit may be ephemeral in nature. As a result, the IP address assigned to the computing unit may be reassigned to a different computing unit that is deployed to the computing unit host. In some embodiments, a computing unit is migrated from one computing unit host to a different computing unit host of the cluster. The computing unit may be assigned a different IP address on the different workload host.

Computing unit host 111 is configured to receive a set of one or more computing units 112 from scheduler 102. Each computing unit of the set of one or more computing unit 112 has an associated IP address. A computing unit of the set of one or more computing units 112 may be configured to communicate with another computing unit of the set of one or more computing unit 112, with another computing unit included in the set of one or more computing unit 122, or with an endpoint external to system 100.

When a computing unit is terminated, the IP address assigned to the terminated computing unit may be reused and assigned to a different computing unit. A computing unit may be destroyed. Each time a computing unit is resurrected, it is assigned a new IP address. This makes it difficult to associate a computing unit with a namespace.

Computing unit host 111 includes host kernel 113. Host kernel 113 is configured to control access to the CPU associated with computing unit host 111, memory associated with computing unit host 111, input/output requests associated with computing unit host 111, and networking associated with computing hosts 111.

Flow log agent 114 monitors API Server 103 to determine metadata associated with the one or more computing units 112 and/or the metadata associated with the one or more computing units 122. Flow log agent 114 extracts and correlates metadata and network policy for the one or more computing units of computing unit host 111 and the one or more computing units of the one or more other computing unit hosts of the cluster. For example, flow log agent 114 may have access to a data store that stores a data structure identifying the permissions associated with a computing unit. In some embodiments, flow log agent 114 uses such information to determine which computing units of the cluster to which a computing unit is permitted to communicate and which computing units of the cluster to which the computing unit is not permitted to communicate.

Flow Log Agent 114 programs kernel 113 to include flow log data plane 115. Flow log data plane 115 causes kernel 113 to generate flow events associated with each of the computing units on the host. A flow event may include an IP address associated with a source computing unit, a source port, an IP address associated with a destination computing unit, a destination port, a protocol used, as well as the network metrics associated with the flow. For example, a first computing unit of the set of one or more computing units 112 may communicate with another computing unit in the set of one or more computing unit 112 or a computing unit included in the set of one or more computing unit 122. In some embodiments, flow log data plane 115 causes kernel 113 to record the standard network 5-tuple as a flow event and provides the flow event to flow log agent 114. In some embodiments, flow log data plane 115 causes kernel 113 to include computing unit metadata and/or network policy metadata in the generated flow events. For example, the Host Kernel 113 may provide a flow event that includes the source IP address, the source port, the destination IP address, the destination port, and the protocol. The flow event may also include network metrics associated with the flow, such as the number of bytes and packets.

Flow log agent 114 is configured to determine the computing unit to which the flow event pertains. Flow log agent 114 determines this information in various embodiments based on the IP address associated with a computing unit or based on a network interface associated with a computing unit. Flow log agent 114 is configured to generate a scalable network flow event by combining the flow event information with metadata associated with the computing unit, such as the cluster identity associated with the computing unit, a namespace identity associated with the computing unit, the computing unit identity, and/or one or more labels associated with the computing unit. Flow log agent 114 is configured to combine the flow event information with metadata associated with the network policy related to the flow event. Flow log agent 114 is configured to store the scalable network flow event in a flow log. Each event included in the flow log includes the pertinent information associated with a computing unit when the flow log entry is generated. Thus, when the flow log is reviewed at a later time, the flow log may be easily understood as to which computing unit communicated with which other computing unit in the cluster.

When a data packet is received at a service, the data packet is load balanced to one of a plurality of computing units 112 associated with the service. Host kernel 113 performs load balancing by using IP tables, which are a set of rules that describe how to handle data packets having certain characteristics. Flow log agent 114 may utilize a conntrack module to monitor the data packet as it travels within computing unit host 111. Flow log agent 114 is configured to modify a flow log to include connection tracking information, which indicates how a data packet was network address translated and load balanced by host kernel 113 using IP tables. For example, the flow log may indicate that a flow event for a data packet was sent from a first endpoint, received by a service having an associated IP address, network address translated, and then load balanced to the second endpoint.

Flow log agent 114 includes an eBPF that is attached to host kernel 113. The eBPF analyzes the data packets to generate statistics associated with data packets traveling between services within a namespace and data packets traveling between namespaces, and data packets traveling between a namespace and a non-namespace entity (e.g., namespace A sends data to a private network).

Flow log agent 114 is configured to aggregate flow events associated with the set of one or more computing unit 112. Flow log agent 114 may store the flow events associated with the computing unit host in a flow log and periodically (e.g., every hour, every day, every week, etc.) send the flow log to flow log analyzer 141. In other embodiments, flow log agent 114 is configured to send a flow log to flow log analyzer 141 in response to receiving a command. In other embodiments, flow log agent 114 is configured to send a flow log to flow log analyzer 141 after a threshold number of flow event entries have accumulated in the flow log. In some embodiments, flow events are generated for network traffic sent between endpoints. In some embodiments, flow events are generated for network traffic sent between nodes. In some embodiments, flow events are generated for network traffic sent between servers.

Instead of accumulating each flow event associated with computing unit host 111 and sending each flow event to flow log analyzer 141, flow log agent 114 may use the information associated with the scalable network flow event to aggregate a plurality of flow events into a single flow event. For example, a first computing unit of the one or more computing units 112 may communicate a plurality of times with a second computing unit (of computing unit host 111 or of computing unit host 121). Instead of storing a flow log entry for each of the plurality of communications, flow log agent 114 may combine the plurality of flow events such that a single flow event indicates the number of times the first computing unit communicated with the second computing unit.

Flow log agent 114 may determine network traffic was load balanced before it reached its final destination. Network traffic includes a source and a final destination. The final destination may be associated with an intermediary service that has an associated IP address. The associated IP address may be associated with a set of IP addresses. A flow event may indicate that network address translation was performed and that the network traffic was load balanced to one of the IP addresses included in the set before the network traffic reached its final destination.

Flow log agent 114 is configured to forward the flow log to flow log analyzer 141 via network 131. Network 131 may be one or more of the following: a local area network, a wide area network, a wired network, a wireless network, the Internet, an intranet, or any other appropriate communication network.

Computing unit host 121 may be configured in a similar manner to computing unit host 111 as described above. Computing unit host 121 includes a set of computing units 122, a Host Kernel 123, a Flow Log Agent 124, and a Flow Log Data Plane 125.

Flow log analyzer 141 is configured to receive a plurality of flow logs comprising a plurality of flow events from flow log agents 114, 124, to aggregate the flow events, and to store the flow events in flow log store 151. Flow log analyzer 141 may be implemented on one or more computing devices (e.g., computer, server, cloud computing device, etc.).

Since Flow log analyzer 141 has a complete picture of the network flows for the cluster, flow log analyzer 141 may aggregate flow events from computing unit hosts 111, 121 at a namespace level. In some embodiments, the flow events are aggregated based on information included in a standard network 5-tuple flow data (e.g., source IP address, source port, destination IP address, destination port, protocol). In some embodiments, the flow events are aggregated based on information included in a scalable network flow event.

Flow log analyzer 141 is configured to determine namespace network traffic based on flow events included in the flow logs. Flow log visualizer 161 is configured to visualize (e.g., generate and display a visual representation of) the determined namespace network traffic. Network traffic within a computing environment may be determined at different levels of granularity. In some embodiments, network traffic and associated statistics are determined between namespaces. In some embodiments, network traffic and associated statistics are determined between services within a namespace. In some embodiments, network traffic and associated statistics are determined between computing units associated with a service. The associated statistics may include total packets allowed, total packets denied, total bytes allowed, total bytes denied, etc.

In some embodiments, a flow event is associated with a namespace because the flow event explicitly identifies the namespace identity. In some embodiments, a flow event is associated with a namespace because the flow event includes information that indirectly identifies the namespace to which the flow event is associated (e.g., a computing unit has a particular IP address at a particular moment in time that was part of a group of IP addresses associated with the namespace at the particular moment in time, a computing unit has a particular IP address at a particular moment in time that was part of a group of IP addresses associated with a service included in a namespace at the particular moment in time.).

In some embodiments, the namespace network traffic includes intra-namespace network traffic. Intra-namespace network traffic may include network traffic between services included in a namespace, network traffic between computing units included in a service, network traffic between a computing unit of a first service and a computing unit of a second service, network traffic between a first virtualization container of a computing unit of a first service and a second virtualization container of a computing unit of a first service, or any other combination thereof.

In some embodiments, the namespace network traffic includes inter-namespace network traffic. Inter-namespace network traffic may include network traffic between a first namespace and a second namespace, network traffic between a first service of a first namespace and a first service of a second namespace, network traffic between a first computing unit of a first service of a first namespace and a first computing unit of a first service of a second namespace, network traffic between a first virtualization container of a first computing unit of a first service of a first namespace and a first virtualization container of a first computing unit of a first service of a second namespace, or any combination thereof.

In some embodiments, namespace network traffic includes network traffic associated with an external endpoint. The network traffic to/from an external endpoint may be determined based on a source IP address or a destination IP address associated with a flow event. A set of IP addresses may be defined and network traffic associated with the set of IP addresses may be monitored. For example, the set of IP addresses may be associated with a particular country and the network traffic coming from/to the particular country may be monitored.

Flow log visualizer 161 is configured to visualize the network traffic using a network traffic graph. The network traffic graph may indicate a direction of network traffic between namespaces (e.g., namespace A sends data to namespace B) and may indicate a direction of network traffic between a namespace and a non-namespace entity (e.g., namespace A sends data to a private network). The network traffic graph may indicate a direction of network traffic between services associated with a namespace. The network traffic graph may indicate a direction of network traffic between computing units associated with a service.

The number of namespaces displayed in a network traffic graph may become cumbersome. The network traffic graph is capable of allowing a user to group a plurality of namespaces into different layers. For example, a first layer may include a first set of namespaces, a second layer may include a second set of namespaces, . . . , and an nth layer may include an nth set of namespaces. The network traffic graph is capable of displaying none, one, some, or all of the layers at the same time. The network traffic graph is capable of de-emphasizing one or more of the layers while emphasizing one or more of the layers. The network traffic graph is capable of hiding one or more of the layers while displaying one or more of the layers.

Flow log visualizer 161 is capable of collapsing a plurality of selected namespaces into a single namespace node. Flow log visualizer 161 is capable of generating separate views for network traffic that shares a common namespace. For example, a first set of one or more namespaces may communicate with a common namespace and a second set of one or more namespaces may communicate with the common namespace. Flow log visualizer 161 may generate a first network traffic view that displays a network traffic graph for the first set of one or more namespaces and the common namespace and a second network traffic view that displays a network traffic graph for the second set of one or more namespaces and the common namespace. This may reduce the complexity of the network traffic graph generated by flow log visualizer 161 so that a user viewing the network traffic graph has an easier time digesting the information displayed by the network traffic graph.

In some embodiments, flow log analyzer 141 may analyze the flow logs to monitor DNS lookups. In the event a flow event includes a DNS lookup, flow log analyzer 141 may determine the latency associated with the DNS lookup. Flow log analyzer 141 may generate DNS latency statistics, such as the minimum latency, the maximum latency, and the average latency, for each of the namespaces. In some embodiments, flow log visualizer 161 displays the DNS latency statistics associated with a namespace upon the namespace being selected.

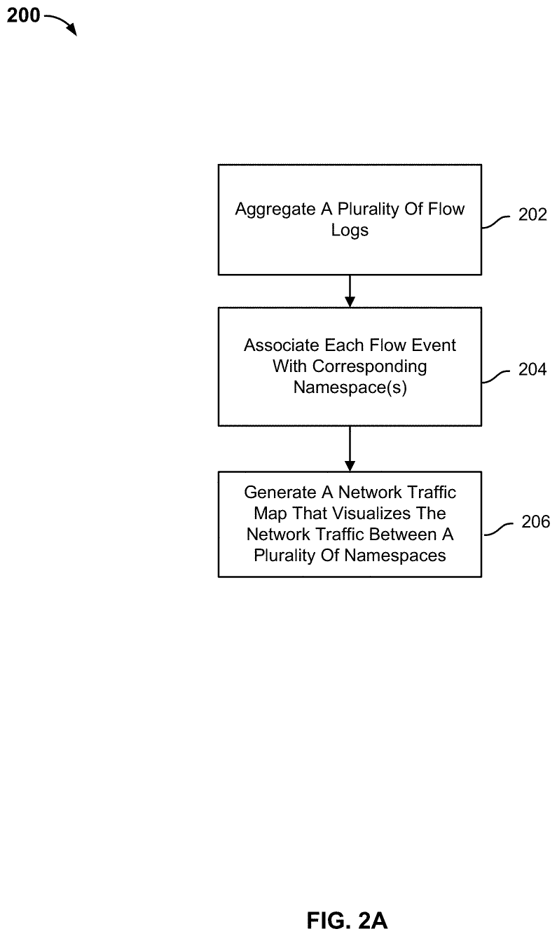

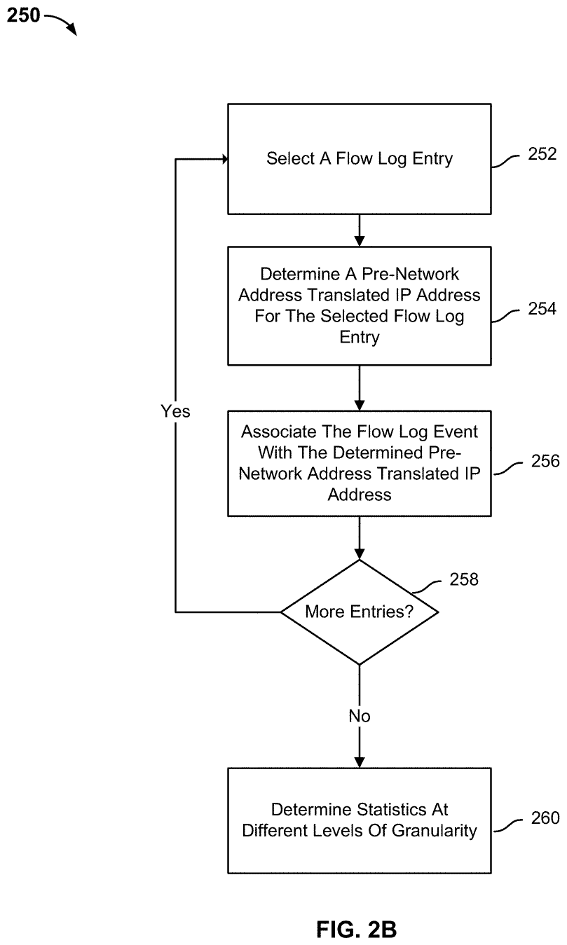

FIG. 2A is a flow diagram illustrating an embodiment of a process of generating a network traffic graph. In the example shown, process 200 may be implemented by a flow log analyzer, such as flow log analyzer 141.

At 202, a plurality of flow logs are aggregated. The plurality of flow logs are received from one or more computing unit hosts. The plurality of flow logs include a plurality of flow events. In some embodiments, a flow event includes information included in a standard network 5-tuple flow data (e.g., source IP address, source port, destination IP address, destination port, protocol). In some embodiments, a flow event includes information included in a scalable network flow event. The scalable network flow event may include, for each source and destination computing unit one or more of the following: a cluster identity, a namespace identity, a computing unit identity, one or more computing unit labels, the standard network 5-tuple flow data, and/or network metrics associated with the flow event (e.g., number of bytes and packets). The metadata may include computing unit metadata and/or network policy metadata.

At 204, flow events are associated with corresponding namespace(s). For each flow event included in the plurality of flow logs a corresponding namespace with which the flow event is associated is determined including by determining a corresponding intermediary associated with the flow event. In some embodiments, a flow event is associated with a namespace because the flow event explicitly identifies the namespace identity. In some embodiments, a flow event is associated with a namespace based on information included in the flow event that indirectly identifies the namespace to which the flow event is associated (e.g., a computing unit has a particular IP address at a particular moment in time that was part of a group of IP addresses associated with the namespace at the particular moment in time.).

In some embodiments, a flow event is associated with a namespace by determining the network address translation that was performed on a data packet associated with the flow event. The network address translation that was performed is determined in some embodiments by monitoring the data packet as it travels within a computing unit host and arrives at its final destination. A flow log is modified to include connection tracking information that indicates how a data packet was network address translated and load balanced by a kernel of the computing unit host using IP tables. The pre-determined network address translated IP address may be associated with a particular namespace.

At 206, a network traffic graph that visualizes the network traffic between a plurality of namespaces is generated. A flow log visualizer is configured to visualize the flow log data that was analyzed by a flow log analyzer. The network traffic graph may indicate a direction of network traffic between namespaces (e.g., namespace A sends data to namespace B) and may indicate a direction of network traffic between a namespace and a non-namespace entity (e.g., namespace A sends data to a private network). The network traffic graph may indicate a direction of network traffic between services associated with a namespace. The network traffic graph may indicate a direction of network traffic between computing units associated with a service.

FIG. 2B is a diagram illustrating an embodiment of a process for associating flow events with their corresponding namespace. In the example shown, process 250 may be implemented by a flow log analyzer, such as flow log analyzer 141. In the example shown, process 250 may be implemented by a flow log agent, such as flow log agents 114, 124. In some embodiments, process 250 is implemented to perform some or all of step 204 of process 200.

At 252, a flow log entry is selected. The entry corresponds to a flow event that includes a standard 5-tuple flow data associated with a data packet (e.g., source IP address, source port, destination IP address, destination port, protocol). The flow event indicates that a data packet was sent using a protocol from a first endpoint having the source IP address and the source port to a second endpoint having the destination IP address and the destination port. The flow event may also include network metrics associated with the flow, such as the number of bytes and packets.

At 254, a pre-network address translated IP address is determined for the selected flow log entry. The data packet is network address translated and load balanced by a kernel of a computing unit host prior to arriving at the destination. The kernel utilizes IP tables in determining which computing unit of a plurality of computing units associated with a service to send the data packet. A conntrack module is utilized to determine connection information between a service and a computing unit. For example, the conntrack module may determine that a service associated with a first IP address load balances data packets to a set of computing units that includes destination, each computing unit having a corresponding IP address. The IP address of the service may be determined by the conntrack module. The namespace associated with the service may be determined based on the determined IP address of the service.

At 256, the flow log event is associated with the determined pre-network address translated IP address. The selected flow log entry is modified to include the pre-network address translated IP address. The selected flow log entry may also be modified to include a corresponding service associated with the flow log event and/or a corresponding namespace associated with the flow log event.

At 258, it is determined whether there are more entries in the flow log to analyze. In the event there are more entries to analyze, process 250 returns to 252. In the event the are no more entries to analyze, process 250 proceeds to 260.

At 260, network traffic statistics are determined at different levels of granularity. The network statistics may include total packets allowed, total packets denied, total bytes allowed, total bytes denied, etc. In some embodiments, the network traffic statistics are generated for data packets sent between namespaces. In some embodiments, network traffic statistics are generated for data packets sent between services within a namespace. In some embodiments, network traffic statistics are generated for data packets sent between a namespace and a non-namespace entity (e.g., namespace A sends data to a private network). In some embodiments, network traffic statistics are generated for data packets sent between computing units within a service.

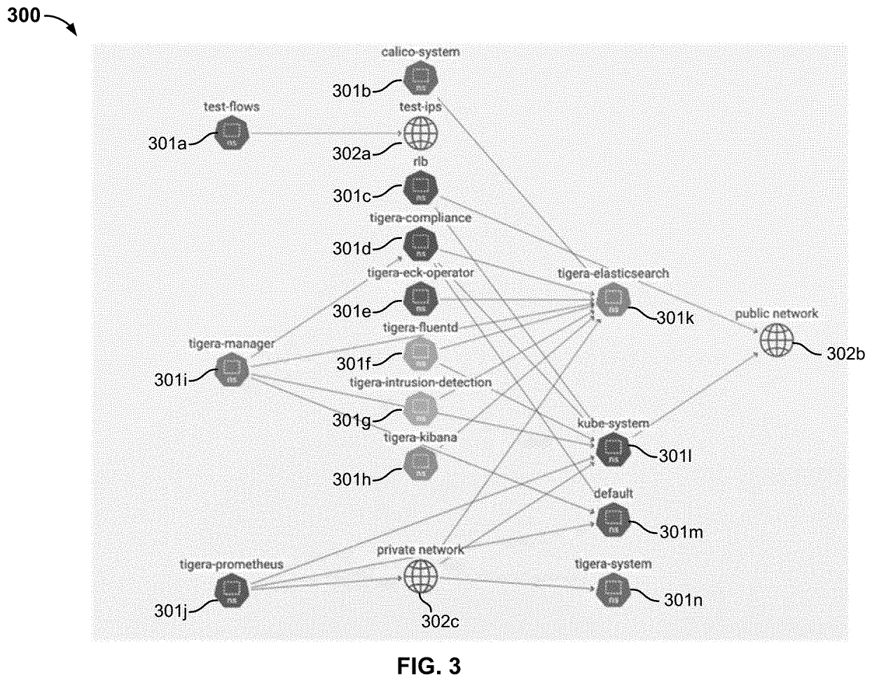

FIG. 3 is a diagram illustrating an embodiment of a network traffic graph. In the example shown, network traffic graph 300 may be generated by a flow log visualizer, such as flow log visualizer 161.

Based on the aggregated flow log data, the flow log analyzer has determined that network traffic flows from namespace 301a to test-ips 302a; from namespace 301b to namespace 301k; from namespace 301c to namespace 3011 and public network 302b; from namespace 301d to namespace 301k, namespace 301l, and namespace 301m; from namespace 301e to namespace 301k; from namespace 301f to namespace 301k, namespace 301l; from namespace 301g to namespace 301k; from namespace 301h to namespace 301k; from namespace 301i to namespace 301d, namespace 301k, namespace 301l, and namespace 301m; from namespace 301j to namespace 301l, namespace 301m, and private network 302c; and from namespace 301l to public network 302b.

A flow log visualizer utilizes the flow log analyzer analysis to generate network traffic graph 300, which illustrates the network traffic amongst a plurality of namespaces 301a, 301b, 301c, 301d, 301e, 301f, 301g, 301h, 301i, 301j, 301k, 301l, 301m, 301n and a plurality of non-namespace entities, for example, test-ips 302a, public network 302b, private network 302c.

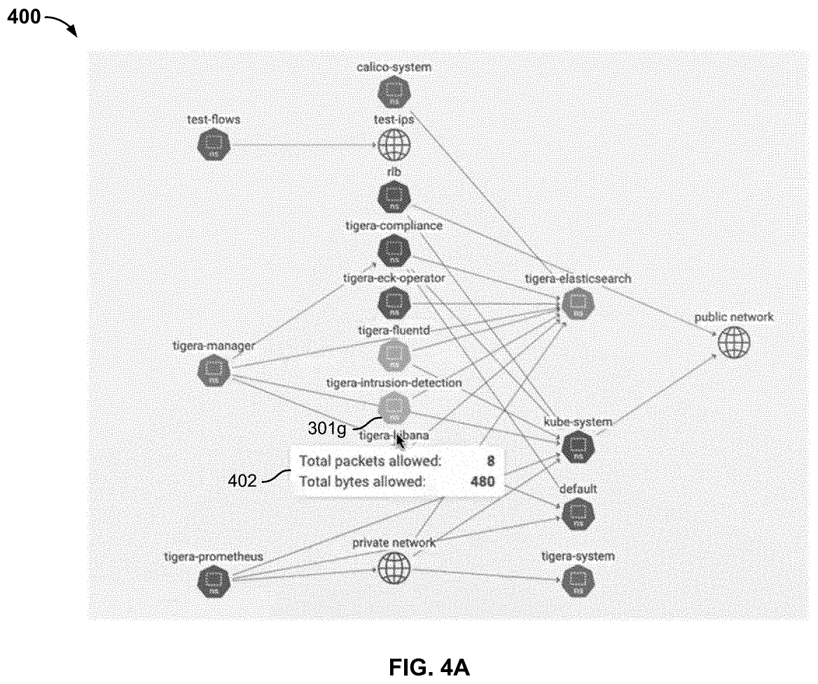

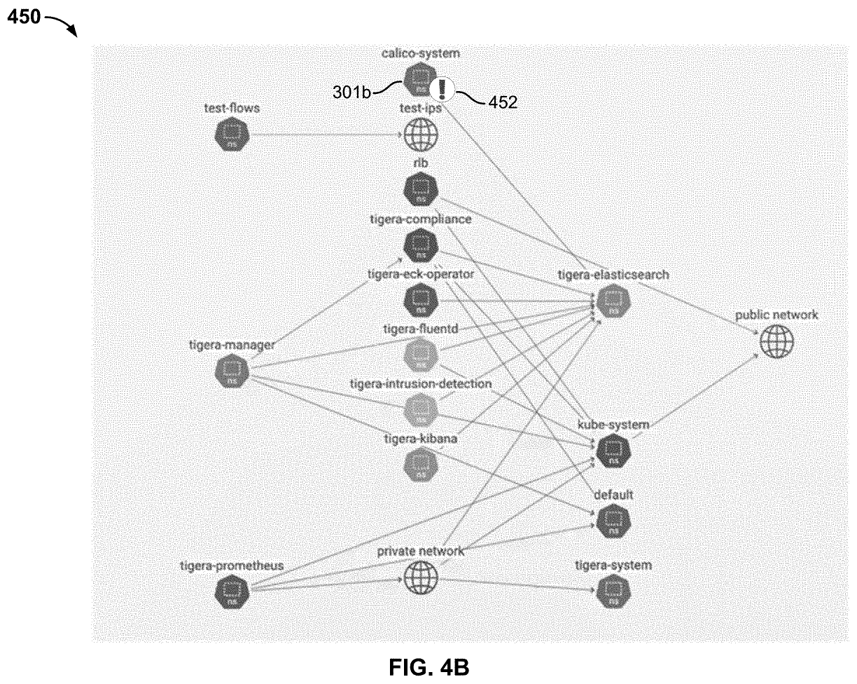

FIG. 4A is a diagram illustrating an embodiment of a network traffic graph. In the example shown, network traffic graph 400 may be generated by a flow log visualizer, such as flow log visualizer 161. Network traffic graph 400 is provided in a user interface. A user can use an input device (e.g., mouse) to control a cursor on the user interface. The user interface is configured to display statistics when the cursor hovers over a namespace. In the example shown, the cursor is hovering over namespace 301g. In response, the user interface is configured to display network traffic statistics associated with namespace 301g.

FIG. 4B is a diagram illustrating an embodiment of a network traffic graph. In the example shown, network traffic graph 450 may be generated by a flow log visualizer, such as flow log visualizer 161. Network traffic graph 450 is provided in a user interface.

A network traffic-based alert may be generated based on one or more network policies. A network traffic-based alert may be associated with one or more conditions. For example, a network traffic-based alert may be generated when there is a DNS lookup error, a communication error, a spike in traffic at a particular location in the network, an unexpected communication to/from a component (namespace, service, pod, virtualization container, etc.) in the network, etc.

In some embodiments, when the one or more conditions associated with a network traffic-based alert is satisfied, the network traffic graph is configured to indicate which namespace the network traffic-based alert is associated. A namespace includes one or more services. In some embodiments, when the one or more conditions associated with a network traffic-based alert is satisfied, the network traffic graph is configured to indicate which service the network traffic-based alert is associated. A service includes one or more computing units (e.g., pods). In some embodiments, when the one or more conditions associated with a network traffic-based alert is satisfied, the network traffic graph is configured to indicate which computing unit the network traffic-based alert is associated. A computing unit includes one or more virtualization containers (e.g., microservices). In some embodiments, when the one or more conditions associated with a network traffic-based alert is satisfied, the network traffic graph is configured to indicate which virtualization container the network traffic-based alert is associated.

In the example shown, the one or more conditions for a network traffic-based alert associated with namespace 301b has been satisfied. As a result, network traffic graph 450 displays alert 452 to notify a user. The user may interact with network traffic graph 450 to receive more information for the network traffic-based alert. For example, the user may click on namespace 301b to expand namespace 301b into its services. The user interface may identify which of the services caused alert 452 to be generated. The user may further click on the service associated with the alert to expand the service into its computing units. The user interface may identify which computing unit caused the alert to be generated. The user may further click on the computing unit associated with the alert to expand the computing unit into its virtualization containers. The user interface may identify which virtualization container caused the alert to be generated.

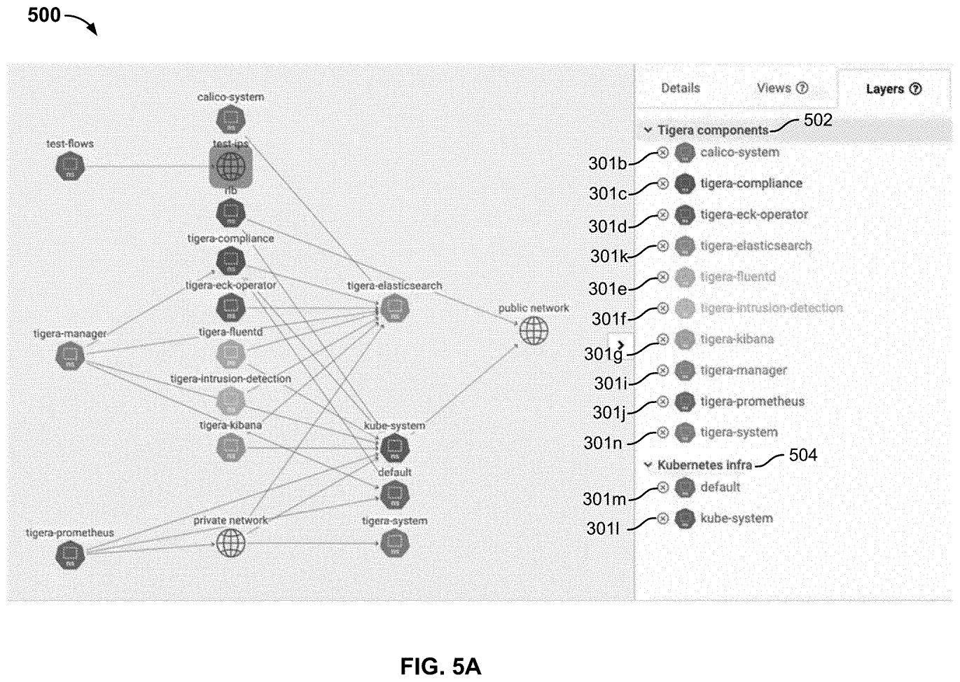

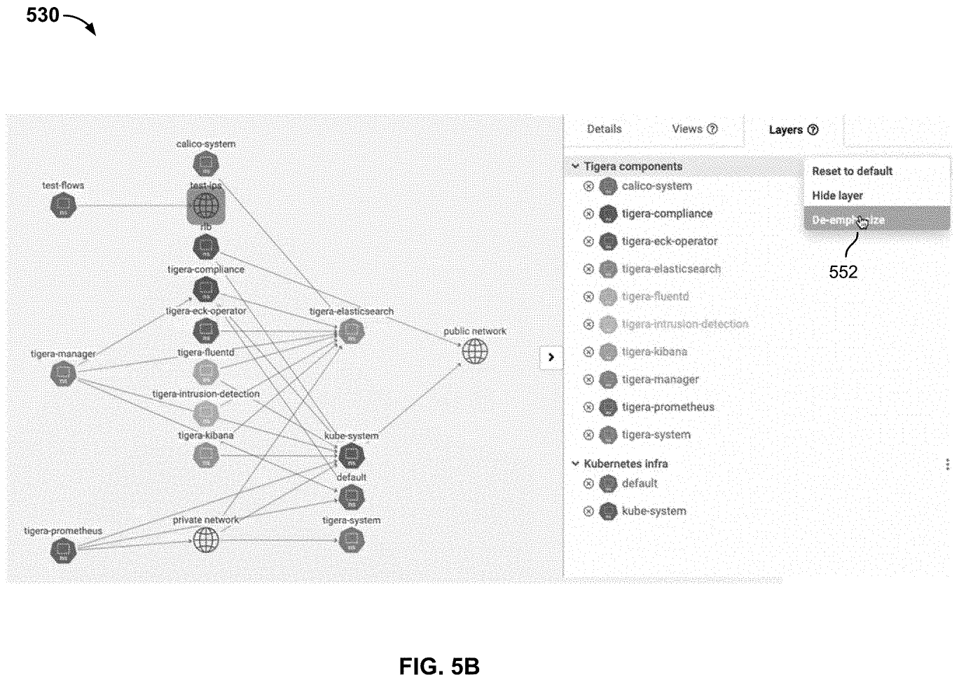

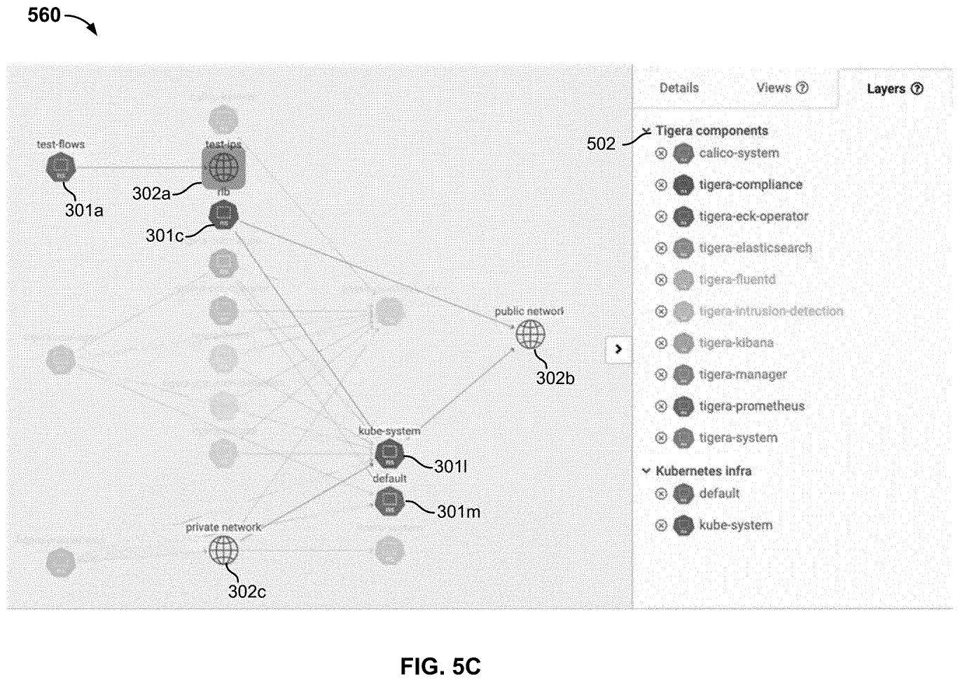

FIG. 5A is a diagram illustrating an embodiment of a network traffic graph. In the example shown, network traffic graph 500 may be generated by a flow log visualizer, such as flow log visualizer 161. Network traffic graph 500 is provided in a user interface.

A network environment may comprised of a plurality of namespaces and non-namespace entities. The number of namespaces and non-namespace entities to display may become cumbersome. The namespaces and/or non-namespace entities may be grouped into layers. This may reduce the complexity of the information displayed in a network traffic graph and present the information in a form that is easier for a user to digest.

In the example shown, a first layer 502 is comprised of namespaces 301b, 301c, 301d, 301k, 301e, 301f, 301g, 301i, 301j, and 301n and a second layer 504 is comprised of namespaces 301m and 301l.

The user interface may provide, as seen in FIG. 5B, a user with the option to “reset to default,” “hide layer” or “de-emphasize.” In the example shown, the user has selected 552 to de-emphasize the namespaces associated with the first layer 502. A result of the user selection is depicted in FIG. 5C. Network traffic graph 560 emphasizes namespaces 301a, 301c, 301l, 301m and non-namespace entities 302a, 302b, 302c while de-emphasizing the namespaces that are included in the first layer 502.

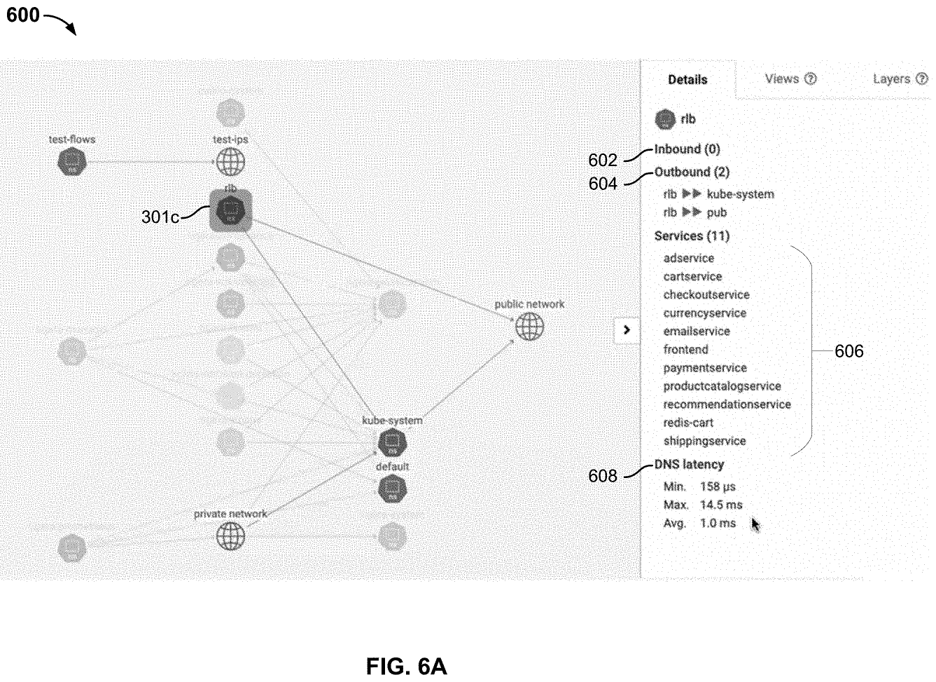

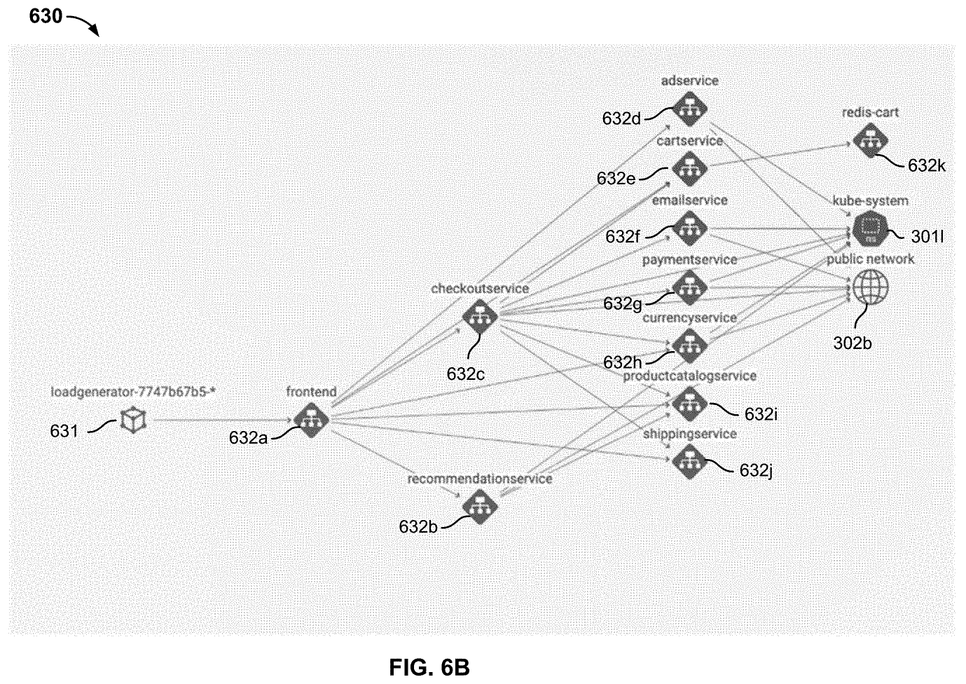

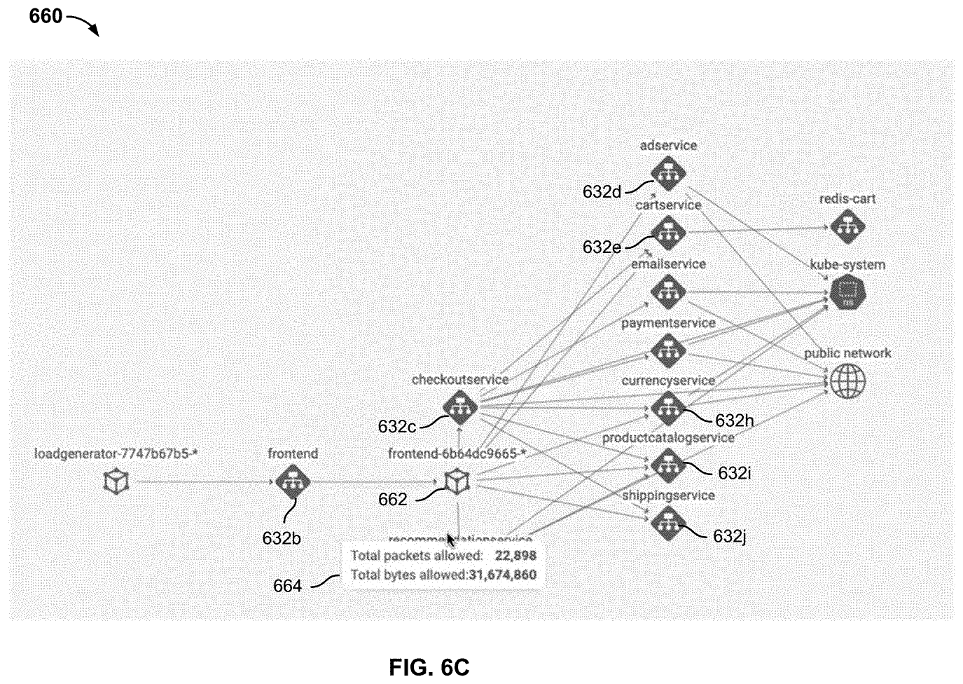

FIG. 6A is a diagram illustrating an embodiment of a network traffic graph. In the example shown, network traffic graph 600 may be generated by a flow log visualizer, such as flow log visualizer 161. Network traffic graph 600 is provided in a user interface.

A user can use an input device (e.g., mouse) to control a cursor on the user interface and select a namespace. In response to the selection, the user interface is configured to display information associated with the selected namespace. The information associated with the selected namespace may include inbound traffic information 602, outbound traffic information 604, services 606 associated with the selected namespace, DNS latency information 608, etc.

The inbound traffic information and the outbound traffic include network traffic direction symbols that may change color based on whether network traffic was successfully sent to/from the namespace. For example, the network traffic direction symbol may be green when network traffic was successfully sent to/from the namespace and red when network traffic was unsuccessfully sent to/from the namespace. Network traffic may be permitted or denied based on one or more network traffic policies associated with a namespace, a service, a computing unit, and/or a virtualization container. The network traffic graph may indicate the one or more network traffic policies that permitted or denied the network traffic. Clicking on the network traffic direction symbol may indicate the number of packets that were denied at the source, the number of packets that were allowed at the source, the number of packets that were denied at the destination, and/or the number of packets that were allowed at the destination.

The services 606 associated with the selected namespace identify the one or more services that are associated with the selected namespace.

The DNS latency information 608 associated with the selected namespace may provide DNS-related information, such as the minimum DNS latency, the maximum DNS latency, and/or the average DNS latency.

In the example shown, a user has selected namespace 502. In response, the user interface is updated to display information associated with namespace 502.

In some embodiments, a user may manipulate the user interface to get more information associated with a namespace. For example, the user may double-click on the namespace. In response to the manipulation, the user interface is updated to display network traffic graph 630.

The network traffic graph 630 depicted in FIG. 6B illustrates an example of network traffic within a namespace. In the example shown, network traffic graph 630 may be generated by a flow log visualizer, such as flow log visualizer 161. Network traffic graph 630 is provided in a user interface.

A user can use an input device (e.g., mouse) to control a cursor on the user interface and select a namespace. In response, the user interface may be updated to display network traffic graph 630. Network traffic graph 630 illustrates the network traffic amongst a plurality of services 632a, 632b, 632c, 632d, 632e, 632f, 632g, 632h, 632i, 632j, 632k and a plurality of non-service entities, for example, load generator 631 (e.g., public internet), namespace 301l, and public network 302b.

Based on the aggregated flow log data, the flow log visualizer has determined that network traffic flows from load generator 631 to service 632a; from service 632a to service 632d, service 632e, service 632c, service 632h, service 632i, service 632j, and service 632b; from service 632b to namespace 301l, public network 302b, and service 632i; from service 632c to service 632e, service 632f, namespace 301l, service 632g, public network 302b, service 632h, service 632i, and service 632j; from service 632d to namespace 301l, and public network 302b, from service 632e to service 632k; from service 632f to namespace 301l and public network 302b; from service 632g to namespace 301l and public network 302b; and from service 632h to namespace 301l and public network 302b.

FIG. 6C is a diagram illustrating an embodiment of a network traffic graph. In the example shown, network traffic graph 660 may be generated by a flow log visualizer, such as flow log visualizer 161. Network traffic graph 660 is provided in a user interface.

A user can use an input device (e.g., mouse) to control a cursor on the user interface and select a service. In response to the selection, the user interface is configured to display one or more computing units associated with the service.

In the example shown, the user has selected service 632b and in response to the selection, computing unit 662 is displayed in network traffic graph 660. Based on the aggregated flow log data, the flow log visualizer has determined that network traffic flows from computing unit 662 to service 632d, service 632e, service 632h, service 632i, and service 632j. In some embodiments, computing unit 662 is one of many replica sets. Instead of displaying each of the replica sets, the replica sets may be illustrated as a single computing unit 662 with an “*” to denote the replica set.

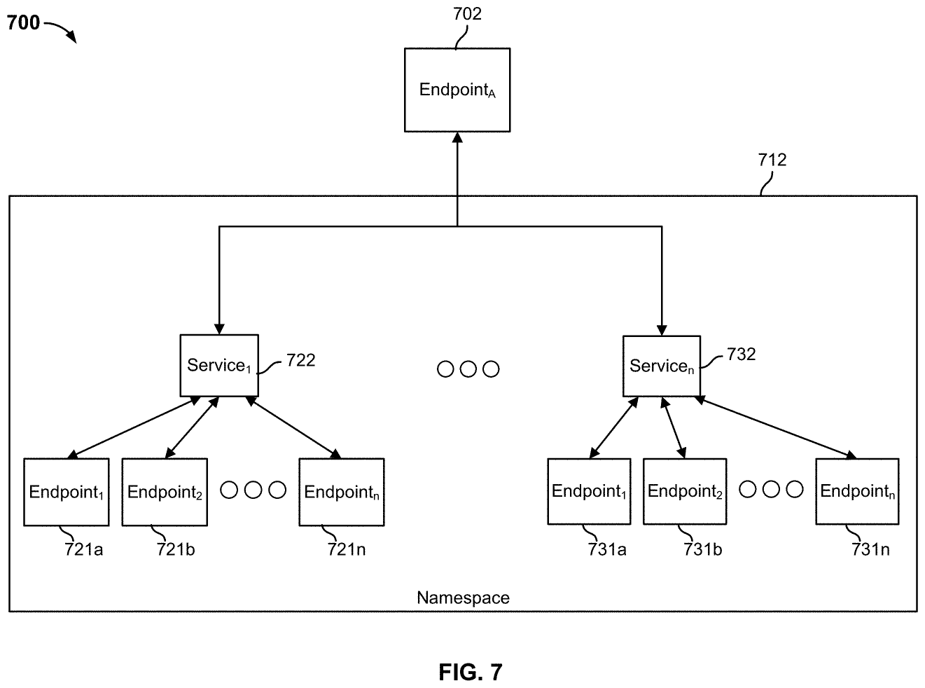

FIG. 7 is a block diagram illustrating an embodiment of a computing environment. In the example shown, computing environment 700 includes an endpoint 702 communicating with a namespace 712. In some embodiments, endpoint 702 is a computing unit associated with a different namespace. In some embodiments, endpoint 702 is a client device that has an associated IP address, such as a computer, server, smart device, or any other network connected computing device.

Namespace 712 includes services 722, 732. Although two services are shown, namespace 712 may be associated with n services. In some embodiments, service 722 sends data packets to service 732. In some embodiments, service 732 sends data packets to service 722.

Services 722, 732 are associated with a corresponding IP address. Service 722 is associated with a first set of endpoints 721a, 721b, 721n. Service 732 is associated with a second set of endpoints 731a, 731b, 731n. Each of the endpoints included in the first and second sets is associated with a corresponding IP address. A set of endpoints may be comprised of 1:n endpoints. An endpoint may correspond to a computing unit.

When endpoint 702 sends a data packet to any of the endpoints 721a, 721b, 721n, 731a, 731b, 731n, a flow log event includes an IP address associated with endpoint 702, a port associated with endpoint 702, an IP address associated with one of the endpoints 721a, 721b, 721n, 731a, 731b, 731n, a port associated with one of the endpoints 721a, 721b, 721n, 731a, 731b, 731n, and a protocol.

The flow log entry corresponding to the event does not reflect the service that was used to provide the data packet to the endpoint. A pre-network address translated IP address is determined for the data packet associated with the flow log entry. The data packet is network address translated and load balanced by a kernel of a computing unit host prior to arriving at one of the endpoints 721a, 721b, 721n, 731a, 731b, 731n. The kernel utilizes IP tables in determining which endpoint of a plurality of endpoints associated with a service to send the data packet. A conntrack module is utilized to determine connection information between a service and an endpoint. For example, the conntrack module may determine that a service associated with a first IP address load balances data packets to a set of endpoints, each endpoint having a corresponding IP address. The IP address of the service may be determined by the conntrack module. This enables the specific service that received the data packet to be determined. As a result, network traffic graphs may be generated using such information.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
aggregating a plurality of flow logs associated with a plurality of computing units;
determining for each flow event included in the plurality of flow logs a corresponding namespace with which the flow event is associated including by determining a corresponding intermediary associated with the flow event; and
generating a network traffic map that visualizes network traffic between a plurality of namespaces based in part on the determined intermediaries associated with the flow events.

2. The method of claim 1, wherein a flow event includes a source internet protocol address, a source port, a destination internet protocol address, a destination port, and a protocol.

3. The method of claim 1, wherein determining a corresponding namespace with which the flow event is associated includes selecting a flow log entry from the plurality of flow logs.

4. The method of claim 3, wherein determining for each flow event included in the plurality of flow logs a corresponding namespace with which the flow event is associated includes determining a pre-network address translated internet protocol address associated with the selected flow log entry.

5. The method of claim 4, wherein the determined pre-network address translated internet protocol address corresponds to an intermediary associated with the flow event.

6. The method of claim 5, wherein the intermediary associated with the flow event is a service included in a namespace.

7. The method of claim 4, wherein determining the pre-network address translated internet protocol address associated with the selected flow log entry includes utilizing a connection tracking module.

8. The method of claim 7, wherein the connection tracking module indicates how a data packet associated with the flow event was load balanced to a destination computing unit.

9. The method of claim 1, wherein the generated network traffic map indicates network statistics associated with data packets sent from a first namespace to a second namespace.

10. The method of claim 1, wherein the generated network traffic map indicates a failure associated with data packets being sent from a first namespace to a second namespace.

11. The method of claim 1, further comprising:
receiving a selection of a first namespace of the plurality of namespace; and
in response to the selection, updating the network traffic map to indicate network traffic between a plurality of services included in the first namespace.

12. The method of claim 11, wherein the updated network traffic map indicates network statistics associated with data packets sent from a first service included in the first namespace to a second service included in the first namespace.

13. The method of claim 1, further comprising generating a layer within the generated network traffic map based on a selection of at least two namespaces of the plurality of namespaces.

14. A system, comprising:
a processor configured to:
aggregate a plurality of flow logs associated with a plurality of computing units;
determine for each flow event included in the plurality of flow logs a corresponding namespace with which the flow event is associated including by determining a corresponding intermediary associated with the flow event; and
generate a network traffic map that visualizes network traffic between a plurality of namespaces based in part on the determined intermediaries associated with the flow events; and
a memory coupled to the processor and configured to provide the processor with instructions.

15. The system of claim 14, wherein to determine a corresponding namespace with which the flow event is associated, the processor is configured to select a flow log entry from the plurality of flow logs.

16. The system of claim 15, wherein to determine a corresponding namespace with which the flow event is associated, the processor is configured to determine a pre-network address translated internet protocol address associated with the selected flow log entry.

17. The system of claim 16, wherein the determined pre-network address translated internet protocol address corresponds to an intermediary associated with the flow event.

18. The system of claim 16, wherein to determine the pre-network address translated internet protocol address associated with the selected flow log entry, the processor is configured to utilize a connection tracking module.

19. The system of claim 18, wherein the connection tracking module indicates how a data packet associated with the flow event was load balanced to a destination computing unit.

20. A computer program product embodied in a non-transitory computer readable medium and comprising computer instructions for:
aggregating a plurality of flow logs associated with a plurality of computing units;
determining for each flow event included in the plurality of flow logs a corresponding namespace with which the flow event is associated including by determining a corresponding intermediary associated with the flow event; and
generating a network traffic map that visualizes network traffic between a plurality of namespaces based in part on the determined intermediaries associated with the flow events.
